(19) United States
(12) Patent Application Publication
(10) Pub. No.: US 2007/0112826 A1
(43) Pub. Date: May 17, 2007

(54) Multimedia transcoding based on remaining storage capacity

(75) Inventor: Indra Laksono, Richmond Hill (CA)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: VIXS Systems, Inc., Toronto (CA)

(21) Appl. No.: 11/271,388

(22) Filed: Nov. 10, 2005

(51) Int. Cl. G06F 7/00

(52) U.S. Cl. 707/102

(57) ABSTRACT

A first data storage requirement of a first multimedia data representative of a multimedia program to be stored at a storage device is determined. An available remaining storage capacity of the storage device is determined. The first multimedia data is transcoded to generate a second multimedia data having a second data storage requirement that is less than the first data storage requirement if the first storage requirement exceeds the available remaining storage capacity of the storage device. Alternately, a second multimedia data stored at the storage device and representative of a second multimedia program is selected based on user preference information. The second multimedia data is transcoded to generate a third multimedia data having a lower data storage requirement. The third multimedia data is stored at the storage device in place of the second multimedia data to increase the available remaining storage capacity of the storage device.

### FIELD OF THE DISCLOSURE

The present disclosure relates generally to processing and storing multimedia data.

### BACKGROUND

Multimedia devices frequently store received multimedia data for subsequent access. Conventional devices typically implement either a pass-through policy whereby encoded multimedia data is stored with minimal processing, or by implementing a transcoding policy whereby all received multimedia data is transcoded before it is stored. To illustrate, multimedia devices having a smaller screen or limited bandwidth often will transcode the received multimedia data based on a reduced resolution so as to reduce the storage requirement of the multimedia data. However, these conventional devices typically utilize fixed transcoding so that all multimedia data is transcoded to substantially the same degree. As a result, such devices may run out of storage capacity before all desired multimedia data can be stored. Further, multimedia data of particular interest to a viewer may be transcoded to a lower-quality content than otherwise would be necessary. Accordingly, improved techniques for processing and storing multimedia data would be advantageous.

### BRIEF DESCRIPTION OF THE DRAWINGS

The purpose and advantages of the present disclosure will be apparent to those of ordinary skill in the art from the following detailed description in conjunction with the appended drawings in which like reference characters are used to indicate like elements, and in which:

FIG. 1 is a block diagram illustrating an exemplary multimedia transcoding/storage system in accordance with at least one embodiment of the present disclosure.

FIG. 2 is a flow diagram illustrating an exemplary method for transcoding multimedia data based on remaining storage capacity in accordance with at least one embodiment of the present disclosure.

FIG. 3 is a flow diagram illustrating an exemplary method for transcoding multimedia based on priority in accordance with at least one embodiment of the present disclosure.

FIG. 4 is a block diagram illustrating an exemplary personal video recorder (PVR) implementing the multimedia transcoding/storage system of FIG. 1 in accordance with at least one embodiment of the present disclosure.

### DETAILED DESCRIPTION OF THE DISCLOSURE

The following description is intended to convey a thorough understanding of the present disclosure by providing a number of specific embodiments and details involving the processing and storage of multimedia data. It is understood, however, that the present disclosure is not limited to these specific embodiments and details, which are exemplary only. It is further understood that one possessing ordinary skill in the art, in light of known systems and methods, would appreciate the use of the disclosure for its intended purposes and benefits in any number of alternative embodiments, depending upon specific design and other needs.

In accordance with one aspect of the present disclosure, a method is provided. The method includes determining a first data storage requirement of a first multimedia data representative of a multimedia program to be stored at a storage device and determining an available remaining storage capacity of the storage device. The method further includes transcoding the first multimedia data to generate a second multimedia data having a second data storage requirement that is less than the first data storage requirement when the first storage requirement exceeds the available remaining storage capacity of the storage device.

In one embodiment, the method further includes receiving a size indicator for one or more characteristics of the first multimedia data, wherein the first data storage requirement is determined based on the size indicator. The one or more characteristics include at least one of a bit rate of the first multimedia data, a frame rate of the first multimedia data, a resolution of the first multimedia data, a color depth of the first multimedia data, a content category associated with the first multimedia data, or a statistical representation of the first multimedia data. Transcoding the first multimedia data can include at least one of reducing a bit rate of the first multimedia data, reducing a resolution of one or more video frames of the first multimedia data, reducing a video frame rate of the first multimedia data, reducing a color depth of the first multimedia data, or reducing an audio bit rate of the first multimedia data.

In one embodiment, the method further includes providing the second multimedia data for storage at the storage device. The first multimedia data can be received, transcoded and stored in segments. The storage device can include at least one of a mass storage device of a set top box, a mass storage device of a portable multimedia device, a mass storage device of a personal video recorder, or a shared central storage device providing storage to a plurality of users.

In accordance with another aspect of the present disclosure, the method includes determining that a first multimedia data representative of a first multimedia program is to be stored at a storage device having an available remaining storage capacity that is insufficient for a first data storage requirement of the first multimedia data. The method further includes selecting a second multimedia data stored at the storage device based on user preference information, wherein the second multimedia data is representative of a second multimedia program and has a second data storage requirement. The method additionally includes transcoding the second multimedia data to generate a third multimedia data having a third data storage requirement that is less than the second data storage requirement. The method further includes storing the third multimedia data at the storage device in place of the second multimedia data to increase the available remaining storage capacity of the storage device and storing the first multimedia data at the storage device based on the increased available remaining storage capacity of the storage device. In one embodiment, the method additionally includes selecting a fourth multimedia data stored at the storage device based on the user preference information, wherein the fourth multimedia data is representative of a third multimedia program and has a fourth data storage requirement, transcoding the fourth multimedia data to generate a fifth multimedia data having a fifth data storage requirement that is less than the fourth data storage requirement, and storing the fifth multimedia data at the storage device in place of the forth multimedia data to increase the available remaining storage capacity of the storage device.

In accordance with yet another aspect of the present disclosure, a system is provided. The system includes a first interface to a storage device and a second interface to receive a first multimedia data representative of a multimedia program. The system further includes a storage analysis module coupled to the first and second interfaces. The storage analysis module is to determine a first data storage requirement of the first multimedia data, determine an available remaining storage capacity of the storage device and determine whether the first data storage requirement exceeds the available remaining storage capacity. The system further includes a transcoder coupled to the first and second interfaces and the storage analysis module. The transcoder is to transcode the first multimedia data to generate a second multimedia data having a second data storage requirement that is less than the first data storage requirement in response to the determining that the first data storage requirement exceeds the available remaining storage capacity. The second multimedia data is provided to the first interface for storage at the storage device.

In accordance with an additional aspect of the present disclosure, a system is provided. The system includes a first interface to a storage device having multimedia data representative of one or more multimedia programs and a second interface to receive a first multimedia data representative of a first multimedia program, the first multimedia data having a first data storage requirement. The system further includes a user preference module to determine user preference information and a storage analysis module coupled to the first and second interfaces and the user preference module. The storage analysis module is to determine an available remaining storage capacity of the storage device is insufficient for the first data storage requirement of the first multimedia data and select a second multimedia data stored at the storage device based on user preference information, wherein the second multimedia data is representative of a second multimedia program and has a second data storage requirement. The system further includes a transcoder coupled to the first and second interfaces and the storage analysis module. The transcoder is to transcode the second multimedia data to generate a third multimedia data having a third data storage requirement that is less than the second data storage requirement, wherein the third multimedia data replaces the second multimedia data at the storage device.

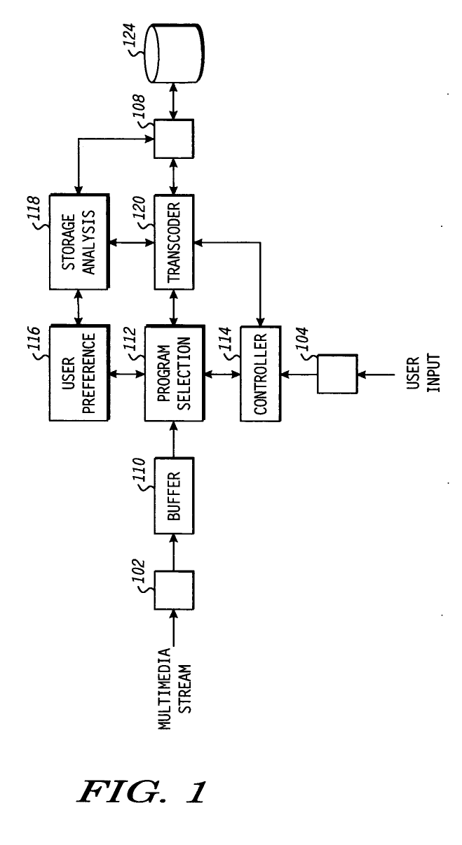

FIGS. 1-4 illustrate exemplary techniques for storing multimedia data on storage devices having limited storage capacity available. In at least one embodiment, the data storage requirement of multimedia data selected for storage is determined and compared with the remaining available storage capacity of the storage device. In the event that the remaining available storage capacity is insufficient to store the multimedia data, the multimedia data is transcoded one or more times to reduce its data size. Once the data storage requirement of the transcoded multimedia data is not greater than the remaining available storage capacity of the storage device, the transcoded multimedia data is provided for storage at the storage device.

In another embodiment, before the selected multimedia data is transcoded, the storage device is analyzed to determine whether a lower-priority multimedia program is stored at the storage device. If so, the data associated with the lower-priority multimedia program is transcoded to reduce its data size and the transcoded data replaces the original data associated with the lower-priority multimedia program at the storage device. Multiple lower-priority multimedia programs can be transcoded so as to increase the available storage capacity of the storage device for the purpose of storing the selected multimedia program. Alternately, the same lower-priority multimedia program can be transcoded to greater extents so as to increase the available storage capacity of the storage device. In the event that a lower-priority multimedia program has been transcoded a predetermined number of times or in the event that the transcoding of a lower-priority multimedia program results in one or more its characteristics to exceed identified thresholds, the lower-priority multimedia program can be selected for removal from, or overwriting at, the storage device.

The term transcoding, as used herein, refers to the processing of multimedia data so as to reduce its data size, such as by converting the multimedia content from one type of audio/video compression format to another audio/video compression format. Thus, the term transrating refers to particular instances of transcoding where the audio/video compression format remains the same.

Referring to FIG. 1, an exemplary multimedia transcoding/storage system 100 for receiving, processing and storing multimedia data is illustrated in accordance with at least one embodiment of the present disclosure. The multimedia transcoding/storage system 100 includes a multimedia stream interface 102, a user interface 104 and a storage device interface 108. The multimedia transcoding/storage system 100 further includes a buffer 110, a program selection module 112, a controller 114, a user preference module 116, a storage analysis module 118, a transcoder 120 and one or more storage devices 124. The transcoder 120 can include a transcoder to transcode multimedia data based on any of a variety of multimedia encoding standards, such as motion pictures experts group (MPEG), MPEG-2 and MPEG-4 based protocols. The storage device 124 includes any of a variety of storage components, such as a magnetic disk drive, an optical disk drive, flash random access memory (RAM), and the like.

The components of the system 100 can be implemented as software, hardware, firmware, or combinations thereof. To illustrate, the system 100 may be implemented as an integrated circuit or a system-on-a-chip (SOC). Alternately, some or all of the components of the system 100 may be implemented as one or more sets of executable instructions that manipulate one or more processors to perform the functions described herein.

As shown, the multimedia stream interface 102 receives one or more multimedia streams for processing and storage at the storage device 124. The multimedia stream interface 102 can include, or be connected to, any of a variety of data transmission elements, such as, for example, a terrestrial-based or satellite-based television transmission network, a data network (e.g., an Ethernet network or the Internet), a wireless network (e.g., an IEEE 802.11-based wireless network or a Bluetooth-based network), and the like. The multimedia streams include multimedia data representative of one or more multimedia programs, such as television programs, movies, and the like.

In one embodiment, some or all of the multimedia data received at the interface 102 can be stored in the buffer 110 until it is selected for processing by the program selection module 112. The buffer 110 can include, for example, a cache, system memory, video memory, and the like.

The program selection module 112 accesses multimedia data representative of a selected multimedia program based on one or more selection criteria. The selection criteria, in one embodiment, represents an indication from a user as to which multimedia program is to be processed for storage in storage device 124. The selection criteria may be received as user preference information via the user interface 104 and interface controller 114. To illustrate, the controller 114 can provide a graphical user interface (GUI), such as an electronic program guide (EPG), for display on a display device (not shown). The user interface 104 can include an infrared or radio frequency (RF) remote control interface to receive user commands as infrared signals or RF signals received from a remote control manipulated by a user. The user therefore can provide user preference information via the remote control and GUI/EPG so as to select multimedia programs for recordation. This information can be stored at the user preference module 116. Alternately, user preference information can be received with, or as part of, the multimedia stream 130 and stored at the user preference module 116. Alternately, the user preference information module 116 can determine user preference information based on an analysis of previous multimedia program selections made by the user.

The user preference information stored at the user preference module 116 and/or received via the user interface 104 and controller 114 includes an identifier of a certain channel or another program indicator associated with a multimedia program that has been selected by the user or another entity for storage at the storage device 124. To illustrate, the user preference information can include a program ID corresponding to EPG information provided by a content provider (e.g., channel guide information provided by a cable television provider or a satellite television provider). The user preference information further may include priority information, where the priority information may identify certain multimedia programs as having a higher priority than other multimedia programs scheduled for recordation. The priority information further may include certain minimum or maximum characteristic thresholds, such as a minimum resolution or a minimum frame rate to which an identified multimedia program can be transcoded.

Based on the selection criteria derived from the user preference information, the program selection module 112 accesses multimedia data associated with a selected multimedia program either directly from a multimedia stream, or alternately from the buffer 110. The program selection module then provides the accessed multimedia data to the transcoder 120 for transcoding and subsequent storage in the storage device 124. As noted above, the selection criteria can include priority criteria whereby multimedia programs marked for storage are selected based on their corresponding priorities. In one embodiment, the multimedia data is accessed and provided to the transcoder 120 in segments. To illustrate, many movies and television programs are segmented into chapters. In such instances, the program selection module 112 can access the multimedia data for a multimedia program on a chapter-by-chapter basis.

Prior to transcoding the multimedia data, or a segment thereof, the storage analysis module 118 determines the data storage requirement of the multimedia data (or segment of multimedia data) prior to transcoding. The storage analysis module 118 can determine the data storage requirement of the multimedia data based on an indication of the data size obtained from the buffer 110 or the program selection module 112. Alternately, a size indicator of the multimedia data can be provided in the multimedia stream 130 (e.g., as data size information as part of the transmitted EPG information), which then may be stored by the user preference module 116 and provided to the storage analysis module 118 when the corresponding multimedia program is selected for processing and storage. The size indicator can include an actual data size value (e.g., a value in units of megabytes or gigabytes). Alternately, the size indicator can represent other characteristics of the multimedia data, such as, for example, its bit rate, its resolution, its frame rate, its color depth, its play length and the like. The storage analysis module 118 then can determine the data storage requirement of the multimedia data from one or more of these characteristics. For example, given a multimedia program having a play length of 60 seconds and a nominal bit rate of 1400 kilobits-per-second, the size of the corresponding multimedia data can be calculated as approximately 10.5 megabytes (i.e., 60 seconds * 1400 kilobits-per-second at 8 bits per byte).

The storage analysis module 118 also determines the remaining available storage capacity of the storage device 124. The remaining available storage capacity may represent the available storage capacity of a portion of the storage device 124 provided for storing multimedia data in general or for a particular multimedia program, or the remaining available storage capacity may represent the available storage capacity of the entire storage device 124. The available remaining storage capacity can be determined based on an indicator of the remaining capacity provided by the storage device 124 via the storage device interface 108. Alternately, the available remaining storage capacity can be determined based on the difference between the total storage capacity of the storage device 124 (determined from, for example, the BIOS of a device implementing the system 100) and an indication of the amount of data currently stored at the storage device 124. In another embodiment, the storage analysis module 118 monitors the amount of data provided to the storage device 124 and the amount of data overwritten at the storage device 124 and determines the remaining available data storage capacity based on these amounts and the total storage capacity of the storage device 124.

The storage analysis module 118 compares the data storage requirement of the selected multimedia data with the remaining available storage capacity of the storage device 124 to determine whether the storage device 124 has enough remaining storage capacity to store the selected multimedia data without further reduction. If the multimedia program can be stored without further reduction, the transcoder 120 provides the multimedia data to the storage device interface 108 for storage at the storage device 124 with little or no alteration to the multimedia data.

Otherwise, if the multimedia cannot be stored unaltered in the storage device 124 due to insufficient storage capacity, the transcoder 120 can determine transcoding parameters sufficient to reduce the size of the resulting transcoded multimedia data so that it can be completely stored at the storage device 124. The transcoding parameters can include, for example, a bit rate reduction, a video frame rate reduction, a color depth reduction, and the like. Further, where the input video is compressed based on one of the MPEG formats, characteristics of the compressed video that contain information such as amount of quantization can be obtained by measuring the observed quantization for each block of a picture and retrieving an arithmetic or geometric mean or median or other statistical measures of the individual quantization values.

The transcoding parameters further can be based on the type or category associated with the multimedia content, such as a “news” category, a “sports” category, and the like. Information indicating the associated category can be explicitly defined based on information provided with the multimedia data or from a separate source, such as an EPG. Alternately, the multimedia content itself can be analyzed to determine one or more appropriate types or categories. To illustrate, motion vectors in each picture can be compared with motion vectors in previous and subsequent pictures to obtain a measure of how much motion is in the video. This measure of motion in the video can be taken for example as the number of zero motion (static) regions of the picture as a percentage of the screen. Depending on the statistical measures of percentage of static regions, as measured over several pictures, the likely category for the segment of video, such as a news broadcast, a soap opera, or sports programming can be identified.

As discussed above, the user preference information stored at the user preference module 116 can include transcoding preference information, such as a minimum resolution, a minimum frame rate, a minimum resolution, a minimum color depth, and the like. In such instances, the transcoder 120 can select the transcoding parameters consistent with the transcoding preference information associated with the multimedia data. Where the input multimedia material contains information identifying the content of the programming, user preference information can be utilized to identify preferred programming. For example, a user could choose to override transcoding parameters associated with a “sports” category so as to change the default bitrate.

The transcoder 120 transcodes the multimedia data in accordance with the identified transcoding parameters so as to reduce the data size of the selected multimedia program. Once the storage analysis module 118 has confirmed that the data storage requirement of the transcoded multimedia data is less than the remaining available storage capacity of the storage device, the transcoded multimedia data is provided to the storage device interface 108 for storage in the storage device 124.

In an alternate embodiment, the storage analysis module 118 determines whether the storage device 124 is storing multimedia data corresponding to another multimedia program having a lower priority than the multimedia data being processed for storage. If a lower-priority multimedia program is present at the storage device 124, the multimedia data corresponding to the lower-priority multimedia program can be transcoded by the transcoder 120 so as to reduce its data size, thereby increasing the storage capacity of the storage device 124 available for storing the higher-priority multimedia program. In one embodiment, the transcoding of the lower-priority multimedia program reduces the data size of the lower-priority multimedia program to a point where the multimedia data of the higher-priority multimedia program can be stored in an unaltered form. Alternately, both the lower-priority multimedia program and the higher-priority program can be transcoded to equivalent or different degrees to increase the available data storage capacity of the storage device 124 so that both multimedia programs can be stored.

The identification of lower-priority multimedia programs at the storage device 124 and their resulting transcoding can be performed in response to the processing of some or all of the multimedia streams to be stored. It will be appreciated that in instances where a lower-priority multimedia program has been transcoded a number of times to make room for other higher-priority multimedia programs at the storage device 124, a user is unlikely to want to access the lower-priority multimedia program due to both its lower priority and substantial reduction in quality as a result of repeated transcoding. Accordingly, these lower-priority multimedia programs can be selected for removal or overwriting, thereby making available additional storage capacity at the storage device 124. Similarly, the storage analysis module 116 can monitor certain characteristics of multimedia programs in the storage device 124. If any of these characteristics fall below an identified threshold as a result of transcoding, the corresponding multimedia program is selected for removal from the storage device 124. To illustrate, if the resolution of a stored multimedia program falls below a minimum resolution threshold, the stored multimedia program could be removed from, or overwritten at, the storage device 124.

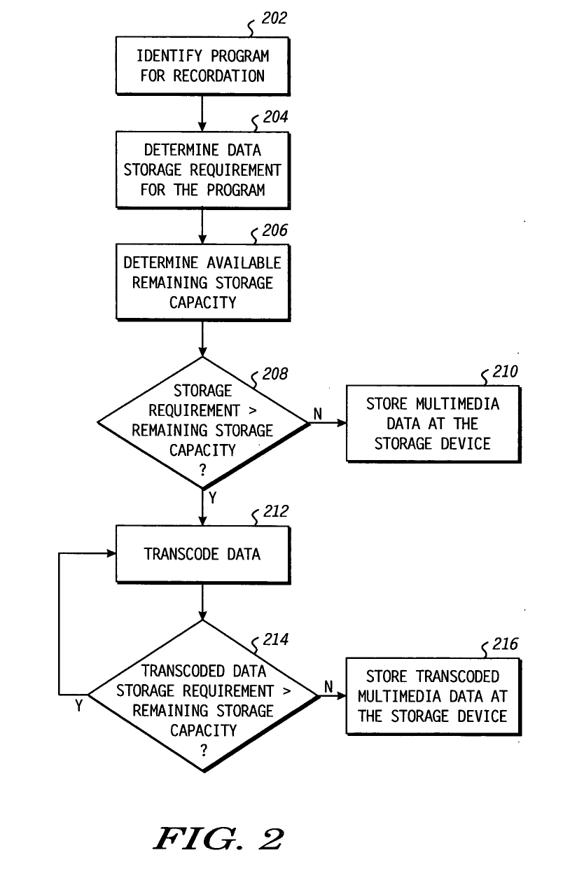

Referring to FIG. 2, an exemplary method 200 for storing multimedia data at a storage device is illustrated in accordance with at least embodiment of the present disclosure. At block 202, a multimedia program is selected for processing and storage. As discussed above, the multimedia program can be selected based on user preference information obtained via, for example, an EPG or other GUI. At block 204 the data storage requirement of the selected multimedia program is determined. The data storage requirement can be determined based on a data size indicator associated with the multimedia data representative of the selected multimedia program. Alternately, the data storage can be determined from one or more characteristics of the multimedia program, such as play time, bit rate, resolution, and the like.

At block 206 the available remaining storage capacity of the storage device(s) used to store multimedia data is determined. The remaining available storage capacity can be determined based on an indicator received from the storage device or another component, or the amount of data stored to the storage device can be monitored and the remaining available storage capacity can be determined from this information in conjunction with the overall storage capacity of the storage device.

At block 208, the data storage requirement of the selected multimedia program is compared with the remaining available storage capacity of the storage device. In the event that the data storage requirement is less than the available storage capacity, the multimedia data representative of the selected multimedia program (or a segment thereof) can be stored at the storage device with minimal or no transcoding or other processing at block 210.

If, however, the data storage requirement of the multimedia program exceeds the remaining available storage of the storage device, transcoding parameters suitable to reduce the data storage requirement of the multimedia program so as to be compatible with the remaining available storage capacity are determined and the multimedia data is transcoded based on these transcoding parameters at block 212. As discussed above, the transcoding parameters can include, for example, a reduction in bit rate, a reduction in frame rate, a reduction in color depth, a reduction in resolution, and the like.

At block 214, the data storage requirement of the transcoded multimedia data is compared with the remaining available storage capacity of the storage device. If the data storage requirement of the transcoded multimedia data is within the remaining available storage capacity of the storage device, the transcoded multimedia data is provided for storage at the storage device at block 216. Otherwise, the flow returns to block 212 whereby the transcoded multimedia data is subjected to another transcoding process so as to further reduce its data storage requirement. The transcoding process of block 212 and the comparison process of block 214 can be repeated until the transcoded multimedia data is determined to not exceed the remaining available storage capacity of the storage device, at which time it can be provided for storage at block 216, or until is determined to be degraded to a point where it is likely of little value to a user, at which time the processing of the selected multimedia program for storage is terminated.

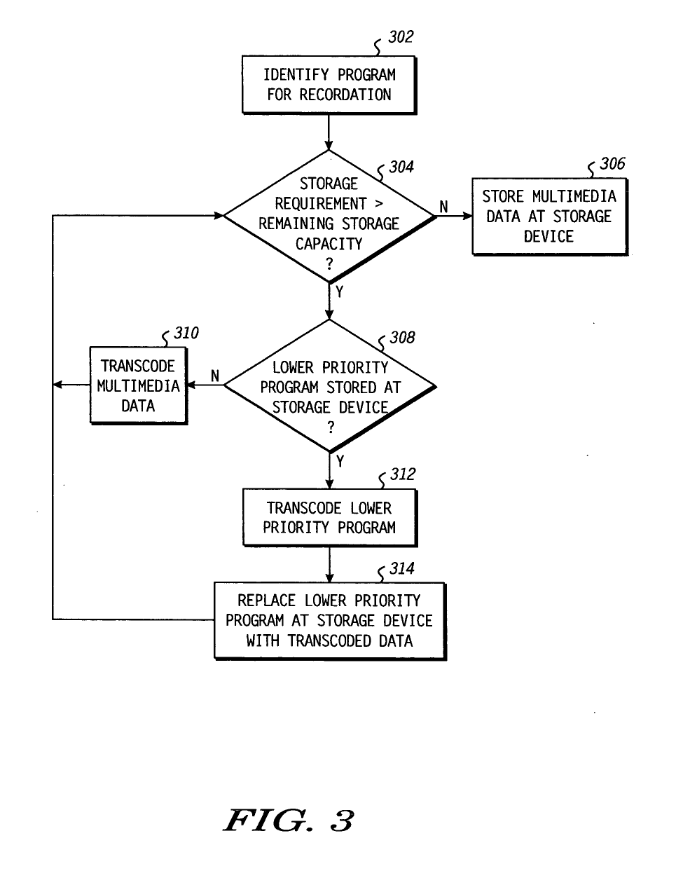

Referring to FIG. 3, an exemplary method 300 for priority-based transcoding and storage of multimedia data is illustrated in accordance with at least embodiment of the present disclosure. At block 302, a multimedia program is selected for processing and storage based on user preference information or other selection criteria. At block 304 the data storage requirement of the selected multimedia program and the remaining available storage capacity of the storage device are determined and compared. In the event that the data storage requirement of the selected multimedia program does not exceed the remaining available storage capacity, the multimedia data representative of the selected multimedia program is stored at the storage device with relatively little or no transcoding at block 306.

However, in the event that the data storage requirement of the selected multimedia program exceeds the remaining available storage capacity of the storage device, at block 308 the multimedia programs stored at the storage device are analyzed to determine whether a multimedia program having a lower priority than the selected multimedia program is being stored. If no lower-priority stored multimedia program is identified, the multimedia data representative of the selected multimedia program is transcoded one or more times at block 310 so as to reduce its data storage requirement to greater extents until it is determined at block 304 that the data storage requirement is within the remaining available storage capacity of the storage device, and therefore can be stored at the storage device at block 306.

If there is a lower-priority multimedia program stored at the storage device, the flow continues to block 312 whereby a lower-priority multimedia program is selected (if there are more than one) and the multimedia data associated with the selected lower-priority multimedia program is transcoded so as to reduce its data size. A lower-priority multimedia program may be selected from a plurality of lower-priority multimedia programs in any of a variety of manners, such as by selecting the lowest-priority multimedia program, by selecting the lower-priority multimedia program having the most data, by selecting the lower-priority multimedia program having the highest resolution, and the like.

At block 314, the data associated with the selected lower-priority program is replaced at the storage device with its transcoded version so as to free up additional storage capacity at the storage device. The flow then returns to block 304 whereby the remaining available storage capacity of the storage device is updated and the data storage requirement of the selected multimedia program is compared to the updated remaining storage capacity. If the data storage requirement of the selected multimedia program continues to exceed the updated remaining available storage capacity of the storage device, the processes represented by blocks 308, 310, 312 and 314 may be repeated one or more times until the storage device has the capacity to store the selected multimedia program. For subsequent iterations, different lower-priority multimedia programs can be selected for transcoding using, for example, round-robin selection, or the same lower-priority multimedia program can be repeatedly selected for transcoding. As noted above, a lower-priority multimedia program may be removed from or overwritten at the storage device to increase the remaining available storage capacity of the storage device if the lower-priority multimedia program has been transcoded a certain number of times or if one or more of its characteristics, such as resolution, frame rate, or bit rate, falls below a minimum threshold.

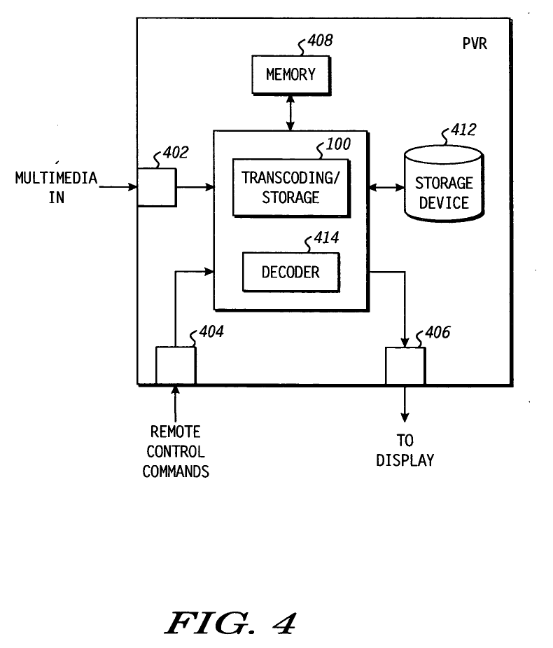

Referring to FIG. 4, an exemplary personal video recorder (PVR) 400 utilizing the multimedia transcoding/storage system 100 of FIG. 1 is illustrated in accordance with at least one embodiment of the present disclosure. The PVR 400 includes a cable interface 402, a remote control interface 404, a display interface 406, memory 408, a multimedia processor 410 and a storage device 412. The multimedia processor 410 includes the multimedia transcoding/storage system 100 and a decoder 414.

The cable interface 402 receives multimedia information via a cable transmission, satellite transmission, terrestrial transmission, or data network transmission. The data representative of selected multimedia programs can be buffered in memory 408 or another buffer and then processed by the multimedia processor 410 in response to user input received via the remote control interface 404 or in response to user preference information previously received. The processing of the multimedia data can include using the transcoding/storage system 100 to process and store the multimedia data in the storage device 412. Alternately, the processing of multimedia data can include decoding multimedia data as it is received or decoding multimedia data accessed from the storage device 412 for display. The resulting decoded and formatted multimedia data then may be provided for display at a display device (not shown) via display interface 406.

Although FIG. 4 illustrates an exemplary implementation of the transcoding/storage. techniques described herein, these techniques may be implemented in any of a variety of devices or other system systems without departing from the scope of the present disclosure. To illustrate, the multimedia transcoding/storage system 100 can be implemented in portable or mobile multimedia devices, such as phones, personal digital assistants, portable video players, or portable audio players, which typically have limited storage capacity.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
determining a first data storage requirement of a first multimedia data representative of a multimedia program to be stored at a storage device;
determining an available remaining storage capacity of the storage device; and
transcoding the first multimedia data to generate a second multimedia data having a second data storage requirement that is less than the first data storage requirement if the first storage requirement exceeds the available remaining storage capacity of the storage device.

2. The method of claim 1, further comprising:
receiving a size indicator for one or more characteristics of the first multimedia data; and
wherein the first data storage requirement is determined based on the size indicator.

3. The method of claim 2, wherein the one or more characteristics includes at least one of a bit rate of the first multimedia data, a frame rate of the first multimedia data, a resolution of the first multimedia data, a color depth of the first multimedia data, a content category associated with the first multimedia data, or a statistical representation of the first multimedia data.

4. The method of claim 1, wherein transcoding the first multimedia data comprises at least one of reducing a bit rate of the first multimedia data, reducing a resolution of one or more video frames of the first multimedia data, reducing a video frame rate of the first multimedia data, reducing a color depth of the first multimedia data, or reducing an audio bit rate of the first multimedia data.

5. The method of claim 1, further comprising providing the second multimedia data for storage at the storage device.

6. The method of claim 5, wherein the first multimedia data is received, transcoded and stored in segments.

7. The method of claim 1, wherein the storage device comprises at least one of a mass storage device of a set top box, a mass storage device of a portable multimedia device, a mass storage device of a personal video recorder, or a shared central storage device providing storage to a plurality of users.

8. A system comprising:
a first interface to a storage device;
a second interface to receive a first multimedia data representative of a multimedia program;
a storage analysis module coupled to the first and second interfaces, the storage analysis module to:
determine a first data storage requirement of the first multimedia data;
determine an available remaining storage capacity of the storage device; and
determine whether the first data storage requirement exceeds the available remaining storage capacity; and
a transcoder coupled to the first and second interfaces and the storage analysis module, the transcoder to transcode the first multimedia data to generate a second multimedia data having a second data storage requirement that is less than the first data storage requirement in response to the determining that the first data storage requirement exceeds the available remaining storage capacity;
wherein the second multimedia data is provided to the first interface for storage at the storage device.

9. The system of claim 8, wherein the storage analysis determines the first data storage requirement based on a size indicator for one or more characteristics of the first multimedia data.

10. The system of claim 9, wherein the one or more characteristics includes at least one of a bit rate of the first multimedia data, a frame rate of the first multimedia data, a resolution of the first multimedia data, a color depth of the first multimedia data, a content category associated with the first multimedia data, or a statistical representation of the first multimedia data.

11. The system of claim 8, wherein a transcoding operation performed on the first multimedia data by the transcoder comprises at least one of a bit rate reduction operation, a video frame resolution reduction operation, a video frame rate reduction operation, a color depth reduction operation, or an audio bit rate reduction operation.

12. The system of claim 8, further comprising:
a buffer coupled to the second interface, the buffer to buffer at least a segment of the first multimedia data; and
wherein the first multimedia data is received, buffered, transcoded and stored on a segment-by-segment basis.

13. The system of claim 8, wherein the system comprises at least one of a set top box, a portable multimedia device, a personal video recorder, or a central storage device that provides storage to a plurality of users.

14. A method comprising:
determining that a first multimedia data representative of a first multimedia program is to be stored at a storage device having an available remaining storage capacity that is insufficient for a first data storage requirement of the first multimedia data;
selecting a second multimedia data stored at the storage device based on user preference information, wherein the second multimedia data is representative of a second multimedia program and has a second data storage requirement;
transcoding the second multimedia data to generate a third multimedia data having a third data storage requirement that is less than the second data storage requirement;
storing the third multimedia data at the storage device in place of the second multimedia data to increase the available remaining storage capacity of the storage device; and
storing the first multimedia data at the storage device based on the increased available remaining storage capacity of the storage device.

15. The method of claim 14, further comprising:
selecting a fourth multimedia data stored at the storage device based on the user preference information, wherein the fourth multimedia data is representative of a third multimedia program and has a fourth data storage requirement;
transcoding the fourth multimedia data to generate a fifth multimedia data having a fifth data storage requirement that is less than the fourth data storage requirement; and
storing the fifth multimedia data at the storage device in place of the forth multimedia data to increase the available remaining storage capacity of the storage device.

16. The method of claim 14, further comprising:
receiving a size indicator for one or more characteristics of the first multimedia data; and
wherein the first data storage requirement is based on the size indicator.

17. The method of claim 14, wherein transcoding the second multimedia data comprises at least one of reducing a bit rate of the second multimedia data, reducing a resolution of one or more video frames of the second multimedia data, reducing a video frame rate of the second multimedia data, reducing a color depth of the first multimedia data or reducing an audio bit rate of the second multimedia data.

18. The method of claim 14, wherein the user preference information indicates that the second multimedia program represented by the second multimedia data is less preferred by a user than multimedia programs represented by other multimedia data stored at the storage device.

19. A system comprising:
a first interface to a storage device having multimedia data representative of one or more multimedia programs;
a second interface to receive a first multimedia data representative of a first multimedia program, the first multimedia data having a first data storage requirement;
a user preference module to determine user preference information;
a storage analysis module coupled to the first and second interfaces and the user preference module, the storage analysis module to:
determine an available remaining storage capacity of the storage device is insufficient for the first data storage requirement of the first multimedia data;
select a second multimedia data stored at the storage device based on user preference information, wherein the second multimedia data is representative of a second multimedia program and has a second data storage requirement; and
a transcoder coupled to the first and second interfaces and the storage analysis module, the transcoder to transcode the second multimedia data to generate a third multimedia data having a third data storage requirement that is less than the second data storage requirement, wherein the third multimedia data replaces the second multimedia data at the storage device.

20. The system of claim 19, wherein the storage analysis module determines that the available remaining storage capacity of the storage device is insufficient based on a size indicator for one or more characteristics of the first multimedia data, and wherein the first data storage requirement is based on the size indicator.

21. The system of claim 20, wherein the one or more characteristics includes at least one of a bit rate of the first multimedia data, a frame rate of the first multimedia data, a resolution of the first multimedia data, a color depth of the first multimedia data, a content category associated with the first multimedia data, or a statistical representation of the first multimedia data.

22. The system of claim 19, wherein a transcoding operation performed on the first multimedia data by the transcoder comprises at least one of a bit rate reduction operation, a video frame resolution reduction operation, a video frame rate reduction operation, a color depth reduction operation, or an audio bit rate reduction operation.

23. The system of claim 20, wherein the user preference information indicates that the second multimedia program represented by the second multimedia data is less preferred by a user than other multimedia programs stored at the storage device.

24. The system of claim 23, wherein the user preference module determines the user preference information based on an analysis of previous user multimedia selections.

25. The system of claim 23, wherein the user preference module determines the user preference information based on multimedia program preferences provided by a user.
